(19) United States
(12) Patent Application Publication
(10) Pub. No.: US 2004/0027389 A1
(43) Pub. Date: Feb. 12, 2004

(54) Method, system and program product for dimensionally locking a display structure in a graphical user interface

(75) Inventors: Velda A. Bartek, Apex, NC (US); Patrick H. Cox, JR., Raleigh, NC (US); Richard N. Spinks, Chapel Hill, NC (US)

Correspondence Address: Jeanine S. Ray-Yarletts, IBM Corporation T81/503, P.O. Box 12195, Research Triangle Park, NC, 27709, US

(73) Assignee: International Business Machines Corporation, Armonk, NY

(21) Appl. No.: 10/213,857

(22) Filed: Aug. 7, 2002

(51) Int. Cl. G09G 5/00

(52) U.S. Cl. 345/788; 345/800; 345/824

(57) ABSTRACT

The present invention provides a method, system and program product for dimensionally locking a display structure (e.g., window, pane, column, etc.) in a graphical user interface (GUI). Specifically, under the present invention each display structure in a GUI is provided with a locking mechanism. When a locking mechanism is engaged, the corresponding display structure cannot be dimensionally adjusted. Thus, even if an unlocked display structure is dimensionally adjusted, the locked display structure will remain unaffected.

### BACKGROUND OF THE INVENTION

1. Field of the Invention

The present invention generally relates to a method, system and program product for dimensionally locking a display structure in a graphical user interface (GUI). Specifically, the present invention allows a window, pane and/or column within a GUI to be dimensionally locked so that adjustment thereof is prevented.

2. Background Art

As information displays become increasingly dense, more windows, panes and columns (collectively referred to as display structures) are shown. As this density increases, the capability to control the amount of information viewed at a single time is vital. Typically, the user must manually re-size the display structures to make sure that all desired information is viewable. In applications that allocate column width within a window proportionally, the adjusted width is maintained until the user performs common window management tasks such as re-sizing or maximizing the window. For example, if the user re-sizes the window to be larger in order to view more information in a column, not only is the column in which the user wishes to view more information enlarged, but the other columns are also enlarged.

Often, too much screen space is allocated to columns with information consisting of a small number of characters or a small icon, while not enough space is apportioned to columns with greater amounts of information. This lack of content dimension discrimination in re-sizing the columns is inefficient. Worse yet, if the user re-sizes the window to be smaller, information that is critical could be obscured. In either case, the column dimensions the user previously set are not explicitly maintained, requiring the user to adjust the columns again.

In view of the foregoing, there exists a need for a method, system and program product for dimensionally locking a display structure (e.g., window, pane, column, etc.) in a graphical user interface (GUI). Specifically, there exists a need for a mechanism by which a display structure in a GUI can be locked so that any dimensional adjustment thereof is prevented. A further need exists for a dimensionally locked display structure to be unaffected when an unlocked display structure is dimensionally adjusted.

### SUMMARY OF THE INVENTION

The present invention generally relates to a method, system and program product for dimensionally locking a display structure (e.g., window, pane, column, etc.) in a graphical user interface (GUI). Specifically, under the present invention each display structure in a GUI is provided with a locking mechanism. When the locking mechanism is engaged, the corresponding display structure cannot be dimensionally adjusted. Thus, even if an unlocked display structure is dimensionally adjusted, the locked display structure will remain unaffected. Once the locking mechanism is disengaged, the display structure is no longer locked and can be dimensionally adjusted.

According to a first aspect of the present invention, a method for dimensionally locking a display structure in a graphical user interface (GUI), is provided. The method comprises: (1) providing a GUI having at least one display structure; and (2) manipulating a locking mechanism to dimensionally lock one of the at least one display structure, wherein dimensional adjustment of an unlocked display structure will not cause dimensional adjustment of the one dimensionally locked display structure.

According to a second aspect of the present invention, a method for dimensionally locking a display structure in a graphical user interface (GUI), is provided. The method comprises: (1) providing a GUI having a plurality of display structures, wherein each of the plurality of display structures includes a locking mechanism; and (2) engaging a particular locking mechanism to dimensionally lock a corresponding display structure, wherein dimensional adjustment of an unlocked display structure will not cause dimensional adjustment of the dimensionally locked display structure.

According to a third aspect of the present invention, a system for dimensionally locking a display structure in a graphical user interface (GUI), is provided. The system comprises: (1) an engagement system for dimensionally locking the display structure in the GUI, wherein dimensional adjustment of an unlocked display structure will not cause dimensional adjustment of the dimensionally locked display structure; and (2) a disengagement system for dimensionally unlocking the dimensionally locked display structure.

According to a fourth aspect of the present invention, a program product stored on a recordable medium for dimensionally locking a display structure in a graphical user interface (GUI) is provided. When executed, the program product comprises: (1) program code for dimensionally locking the display structure in the GUI, wherein dimensional adjustment of an unlocked display structure will not cause dimensional adjustment of the dimensionally locked display structure; and (2) program code for dimensionally unlocking the dimensionally locked display structure.

Therefore, the present invention provides a method, system and program product for dimensionally locking a display structure in a GUI.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having a locking system, according to the present invention.

FIG. 2 an exemplary graphical user interface (GUI) with disengaged column locking mechanisms, according to the present invention.

FIG. 3 depicts the GUI of FIG. 2 with a column locking mechanism engaged.

FIG. 4 depicts an alert generated when an attempt to dimensionally adjust the locked column of FIG. 3 is made.

FIG. 5 depicts the locked column of FIG. 3 when an unlocked column is dimensionally adjusted.

FIG. 6 depicts a GUI with disengaged pane locking mechanisms, according to the present invention.

FIG. 7 depicts a GUI with disengaged pane locking mechanisms and disengaged column locking mechanisms, according to the present invention.

FIG. 8 depicts a method flow diagram, according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

The present invention generally relates to a method, system and program product for dimensionally locking a display structure (e.g., window, pane, column, etc.) in a graphical user interface (GUI). Specifically, under the present invention each display structure in a GUI is provided with a locking mechanism. When a locking mechanism is engaged, the corresponding display structure cannot be dimensionally adjusted. To this extent, the dimensional adjustment of an unlocked display structure will not dimensionally compromise a locked display structure. Once the locking mechanism is disengaged, the display structure is no longer locked and can be dimensionally adjusted.

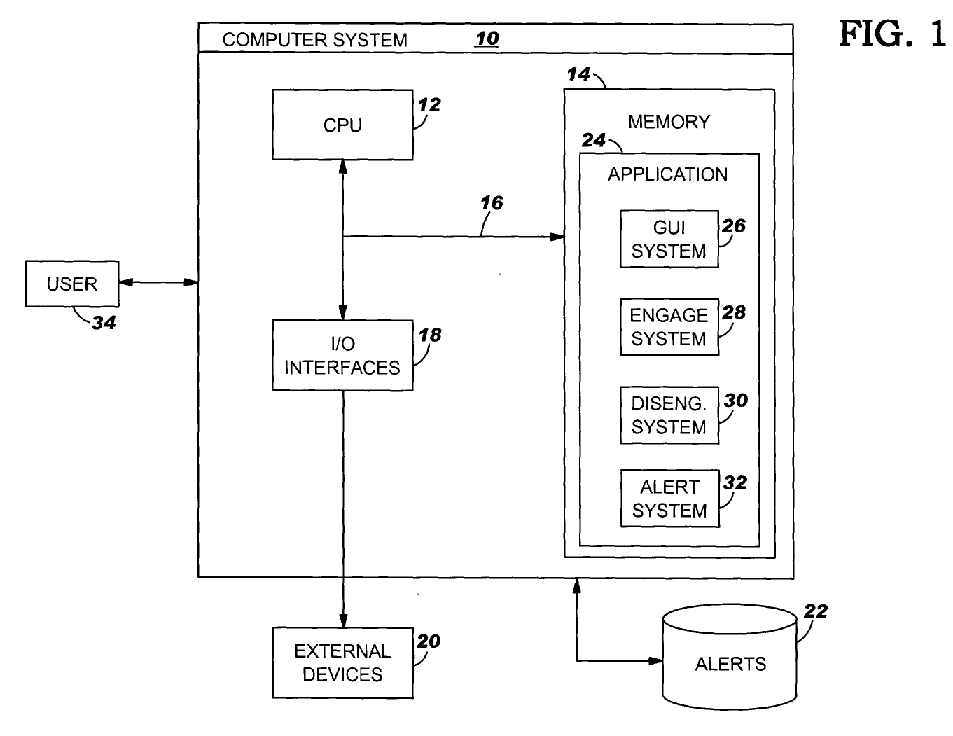

Referring now to FIG. 1, an exemplary computer system 10 is shown. As depicted, computer system 10 including central processing unit (CPU) 12, memory 14, bus 16, input/output (I/O) interfaces 18, external devices/resources 20 and database 22. CPU 12 may comprise a single processing unit, or be distributed across one or more processing units in one or more locations, e.g., on a client and server. Memory 14 may comprise any known type of data storage and/or transmission media, including magnetic media, optical media, random access memory (RAM), read-only memory (ROM), a data cache, a data object, etc. Moreover, similar to CPU 12, memory 14 may reside at a single physical location, comprising one or more types of data storage, or be distributed across a plurality of physical systems in various forms.

I/O interfaces 18 may comprise any system for exchanging information to/from an external source. External devices/resources 20 may comprise any known type of external device, including speakers, a CRT, LED screen, hand-held device, keyboard, mouse, voice recognition system, speech output system, printer, monitor, facsimile, pager, etc. Bus 16 provides a communication link between each of the components in computer system 10 and likewise may comprise any known type of transmission link, including electrical, optical, wireless, etc. In addition, although not shown, additional components, such as cache memory, communication systems, system software, etc., may be incorporated into computer system 10.

Database 22 may provide storage for information necessary to carry out the present invention. Such information could include, among other things, alerts, etc. As such, database 22 may include one or more storage devices, such as a magnetic disk drive or an optical disk drive. In another embodiment, database 22 includes data distributed across, for example, a local area network (LAN), wide area network (WAN) or a storage area network (SAN) (not shown). Database 22 may also be configured in such a way that one of ordinary skill in the art may interpret it to include one or more storage devices. It should be understood computer system 10 is intended to be representative of any type of computerized system. Examples include a server, a client, a workstation, a laptop, a personal digital assistant, etc.

Stored in memory 14 of computer system 10 is application 24 (shown as a program product). Application 24 can be any program capable of generating a GUI. Examples include operating systems such as WINDOWS, web browser programs such as INTERNET EXPLORER, word processing programs such as LOTUS WORDPRO, etc. As depicted, application 24 includes GUI system 26, engagement system 28, disengagement system 30 and alert system 32. GUI system 26 can be any set of program code now known or later developed that “spawns” a GUI. For example, if application 24 is a web browser program, GUI system 26 is a set of program code that opens a web browser when prompted by user 34.

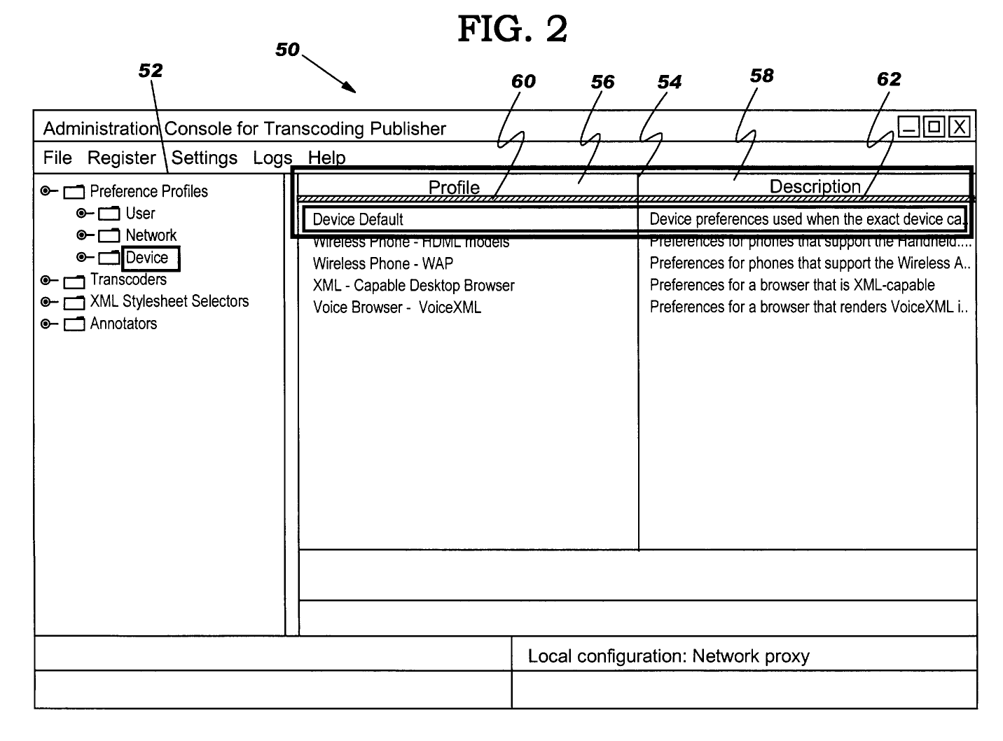

Under the present invention, user 34 can now lock display structures in a GUI to prevent the dimensional adjustment thereof. This functionality is provided by engagement system 28. Specifically, referring to FIG. 2, an exemplary GUI 50 is shown. As depicted, GUI 50 includes panes 52 and 54 and columns 56 and 58. As used herein GUI is intended to mean any interface through which user 34 can interface with computer system 10. To this extent, GUI 50 can also be referred to as a window.

As further shown in FIG. 2, columns 56 and 58 are each equipped with a locking mechanism 60 and 62, respectively. Locking mechanisms 60 and 62 can be any button or the like present in GUI 50 that can be activated/selected by user 34. If locking mechanism 60 is activated by user 34 (e.g., via an input device such as a mouse), engagement system 28 will cause column 56 to be dimensionally locked. Once locked in this manner, column 56 cannot be dimensionally adjusted (horizontally or vertically). If user 34 desires to unlock column 56, user 34 can re-select locking mechanism 60. At this point, disengagement system 30 will release column 56, at which point column 56 can be dimensionally adjusted.

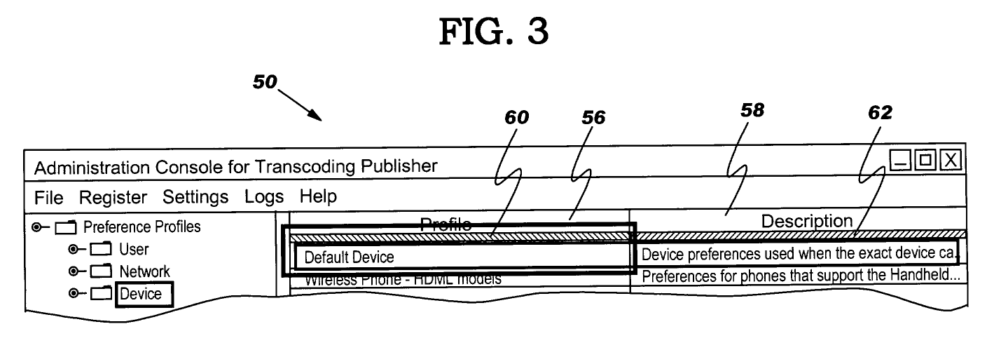

Referring to FIG. 3, interface 50 with locking mechanism 60 of column 56 engaged is shown. As depicted, locking mechanism 60 appears as a button that has been activated (e.g., pressed in). When in this position, column 56 is dimensionally locked. Conversely, locking mechanism 62 of column 58 has not been activated and thus, column 58 is unlocked (i.e., still dimensionally adjustable).

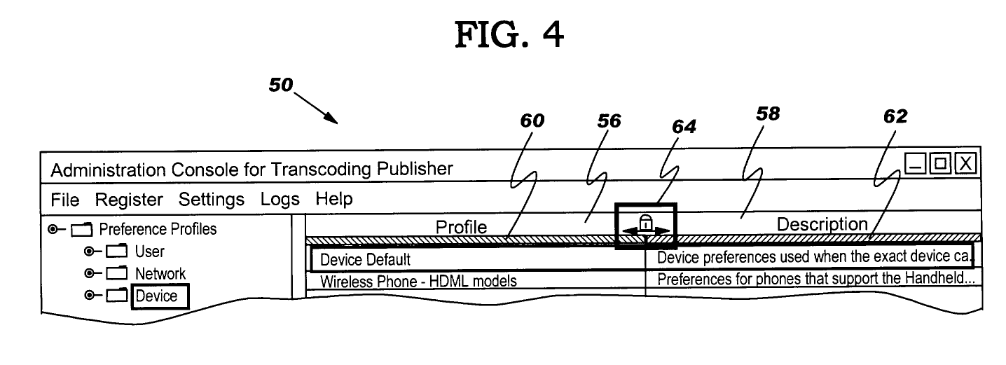

If user 34 attempts to re-size locked column 56, alert system 32 (FIG. 1) can generate and display an alert. As shown in FIG. 4, locking mechanism 60 of column 56 is activated. If user 34 attempts to dimensionally adjust (i.e., re-size) the locked column 56, the attempted adjustment will not be permitted and alert 64 will be generated and displayed. To this extent, alert 64 can be visual, audio or any combination thereof.

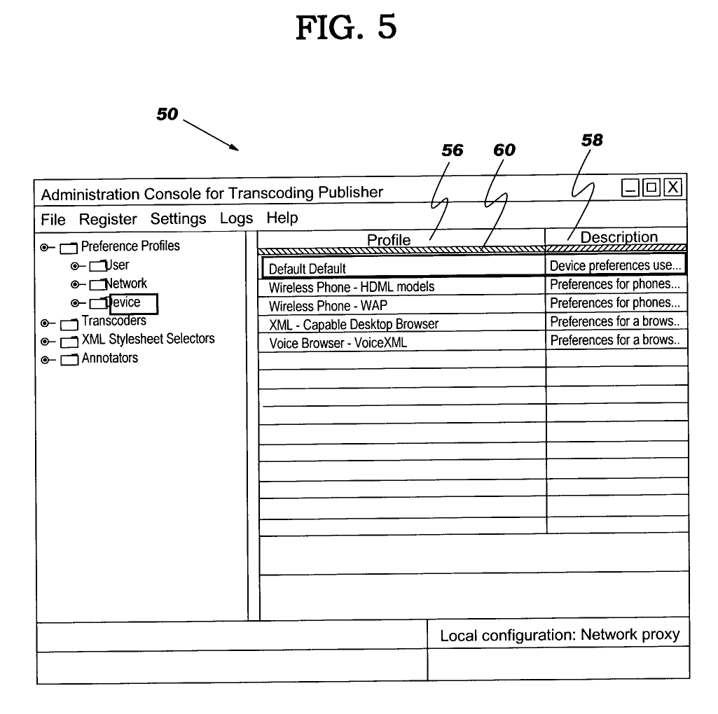

Referring now to FIG. 5, it is demonstrated that dimensional adjustment of unlocked column 58 will not result in dimensional adjustment of locked pane 56. Specifically, as shown, locking mechanism 60 of column 56 is activated while locking mechanism 62 of column 58 is not. Thus, only column 58 is dimensionally adjustable. Under previous systems, dimensional adjustment of unlocked column 58 would result in dimensional adjustment of column 56. For example, if column 58 was enlarged, column 56 would either be enlarged as well, or made smaller to provide more display space for column 58. However, under the present invention, unlocked column 58 can be adjusted, but locked column 56 will be unaffected. If user 34 desires column 58 to be larger, other unlocked display structures (e.g., pane 52) will be adjusted so as not to cause re-sizing of locked column 56.

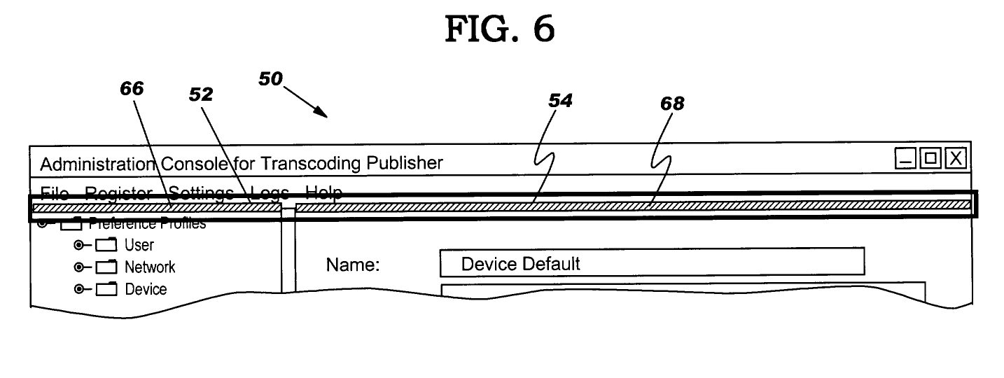

Referring now to FIG. 6, it can be seen that locking mechanisms are not limited to columns in GUI 50. Rather locking mechanisms can be provided for any type of display structure (including GUI/Window 50 itself). As shown, locking mechanisms 66 and 68 have been provided for panes 52 and 54. To this extent, locking mechanisms 66 and 68 function in the same manner as described above. Specifically, upon activation by user 34, engagement system 28 will lock the corresponding display structure. For example, if locking mechanism 68 is activated, pane 54 cannot be dimensionally adjusted. Upon deactivation or re-selection, pane 54 would be unlocked and dimensionally adjustable once again.

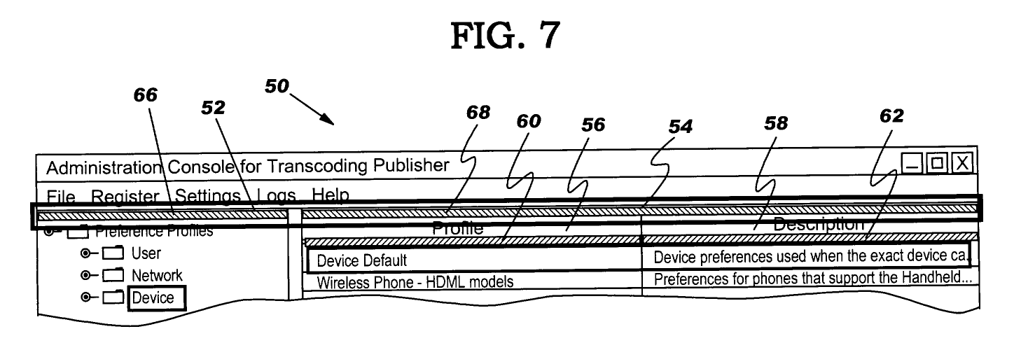

Referring to FIG. 7, it can be seen that all display structures can have locking mechanisms. Specifically, there is no maximum quantity of locking mechanisms that can be provided for GUI 50. As depicted, locking mechanisms 60, 62, 66 and 68 have been provided for columns 56 and 58 and panes 52 and 54, respectively. Each locking mechanism 60, 62, 66 and 68 can be individually activated/engaged and deactivated/disengaged for locking and unlocking a corresponding display structure. Moreover, although not shown, GUI/Window 50 could have its own locking mechanism that would prevent the dimensional adjustment thereof.

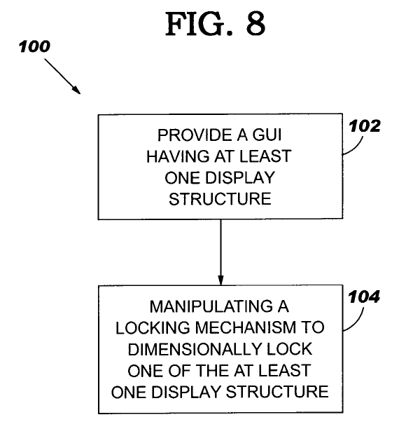

Referring now to FIG. 8, flow diagram of a method 100 according to the present invention is shown. As depicted, first step 102 of method 100 is to provide a GUI having at least one display structure. Once provided, second step 104 is to manipulate a locking mechanism to dimensionally lock one of the at least one display structure. Upon locking, the display structure cannot be adjusted even if an unlocked display structure is dimensionally adjusted.

It is understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, controls computer system 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for dimensionally locking a display structure in a graphical user interface (GUI), comprising:
providing a GUI having at least one display structure; and
manipulating a locking mechanism to dimensionally lock one of the at least one display structure, wherein dimensional adjustment of an unlocked display structure will not cause dimensional adjustment of the one dimensionally locked display structure.

2. The method of claim 1, wherein the manipulating step prevents the one dimensionally locked display structure from being horizontally adjusted.

3. The method of claim 1, wherein the manipulating step prevents the one dimensionally locked display structure from being vertically adjusted.

4. The method of claim 1, wherein the display structure is selected from the group consisting of a window, a pane and a column.

5. The method of claim 1, further comprising displaying an alert when an attempt to dimensionally adjust the one locked display structure is made.

6. A method for dimensionally locking a display structure in a graphical user interface (GUI), comprising:
providing a GUI having a plurality of display structures, wherein each of the plurality of display structures includes a locking mechanism; and
engaging a particular locking mechanism to dimensionally lock a corresponding display structure, wherein dimensional adjustment of an unlocked display structure will not cause dimensional adjustment of the dimensionally locked display structure.

7. The method of claim 6, wherein the engaging step prevents the dimensionally locked display structure from being horizontally adjusted.

8. The method of claim 6, wherein the engaging step prevents the dimensionally locked display structure from being vertically adjusted.

9. The method of claim 6, wherein the display structure is selected from the group consisting of a window, a pane and a column.

10. The method of claim 6, further comprising displaying an alert when an attempt to dimensionally adjust the dimensionally locked display structure is made.

11. A system for dimensionally locking a display structure in a graphical user interface (GUI), comprising:
an engagement system for dimensionally locking the display structure in the GUI, wherein dimensional adjustment of an unlocked display structure will not cause dimensional adjustment of the dimensionally locked display structure; and
a disengagement system for dimensionally unlocking the dimensionally locked display structure.

12. The system of claim 11, further comprising an alert system for generating an alert when an attempt to dimensionally adjust the dimensionally locked display structure is made.

13. The system of claim 11, wherein the engagement system prevents the dimensionally locked display structure from being horizontally adjusted.

14. The system of claim 11, wherein the engagement step prevents the dimensionally locked display structure from being vertically adjusted.

15. The system of claim 11, wherein the display structure is selected from the group consisting of a window, a pane and a column.

16. A program product stored on a recordable medium for dimensionally locking a display structure in a graphical user interface (GUI), which when executed, comprises:
program code for dimensionally locking the display structure in the GUI, wherein dimensional adjustment of an unlocked display structure will not cause dimensional adjustment of the dimensionally locked display structure; and
program code for dimensionally unlocking the dimensionally locked display structure.

17. The program product of claim 16, further comprising program code for generating an alert when an attempt to dimensionally adjust the dimensionally locked display structure is made.

18. The program product of claim 16, wherein the program code for dimensionally locking prevents the dimensionally locked display structure from being horizontally adjusted.

19. The program product of claim 16, wherein the program code for dimensionally locking prevents the dimensionally locked display structure from being vertically adjusted.

20. The program product of claim 16, wherein the display structure is selected from the group consisting of a window, a pane and a column.
